(19) United States
(12) Patent Application Publication
(10) Pub. No.: US 2005/0142524 A1
(43) Pub. Date: Jun. 30, 2005

(54) Standardized cognitive and behavioral screening tool

(76) Inventors: Ely S. Simon, Bayside, NY (US); Glen M. Doniger, Houston, TX (US)

Correspondence Address: DANIEL J SWIRSKY, PO BOX 2345, BEIT SHEMESH, 99544, IL

(21) Appl. No.: 10/984,962

(22) Filed: Nov. 10, 2004

Related U.S. Application Data
(60) Provisional application No. 60/519,005, filed on Nov. 10, 2003.

(51) Int. Cl. G09B 19/00

(52) U.S. Cl. 434/236; 434/362; 434/322

(57) ABSTRACT

A testing system and method for screening and evaluation of cognitive function is provided. The system and method may be used in a waiting area prior to examination by a clinician, thus providing information to the clinician as well as maximizing time spent waiting. The system includes a device for input and output of information, from which a report can be generated. The report is provided in electronic or paper format to the clinician, and further evaluation is at least partially based on the report.

### CROSS REFERENCES TO RELATED APPLICATIONS

The present application claims priority from Provisional U.S. Patent Application Ser. No. 60/519,005, filed on Nov. 10, 2003, incorporated herein by reference in its entirety.

### FIELD AND BACKGROUND OF THE INVENTION

The present invention relates to a standardized screening medical cognitive assessment tool. More specifically, the present invention relates to systems and methods for testing and evaluating cognitive ability as a screening measure, to help determine whether or not further testing is warranted. The systems and methods of the present invention allow a clinician to evaluate an individual's mental condition prior to examination, which can serve as a tool for planning subsequent evaluations/treatments for the individual. The clinician may be a physician, psychologist, neuropsychologist, social worker, or any other person who would perform a psychological or medical evaluation on an individual.

Cognition is a general term for mental processes by which an individual acquires knowledge, solves problems, and plans activities. Cognitive skills include attention, visual/spatial perception, judging and decision-making, problem solving, memory and verbal function, among others. The functional levels of each of these skills can be studied alone or in combination for a particular individual.

Evaluation and quantification of cognitive ability has been a challenge to both scientists and clinicians. This information is important for enabling quick and accurate diagnoses, and for directing treatments. Typically, tests are administered and examinations are performed without adequate consideration of the skill level of the subject being tested, particularly in today's environment of less time spent with each patient. The result of this type of quick evaluation can often be a missed, inaccurate or incomplete diagnosis. Generally, it would be desirable to be able to screen and evaluate certain aspects of cognitive function as well as provide an overall picture of the individual to a clinician prior to examination in an organized and standardized manner.

Numerous screening tests exist for measurement of cognitive function, among them: s the Blessed Test of Orientation, Concentration and Memory; the Dementia Rating; the Mini-Mental State Examination (MMSE), the Short Portable Mental Status Questionnaire, the Wechsler Memory Scale, the Visual Counting Test, and the Clock Drawing Test. While many of these screening instruments are effective in identifying profound impairment associated with dementia, they do not reliably identify the more subtle impairment associated with mild cognitive impairment (MCI)—a pre-dementia state.

Of the existing screening instruments, the Clock Drawing Test is superior to the other screens in that it is brief (under 2 minutes), easy to understand, requires minimal equipment, can be used in populations with different languages and cultures, and can be administered to the hearing impaired. However, as with the other paper-based screening tests, the Clock Drawing Test lacks the precision and objectivity achievable with computerized testing. Further, it does not measure reaction time in addition to accuracy and is relatively restricted in the cognitive domains it taps (i.e., executive function, visual spatial). While the Clock Drawing Test may take under 2 minutes to administer, there is an overhead in scoring time following testing. Also, it must be administered by a physician or a trained healthcare professional. Moreover, memory impairment, the hallmark of MCI, is not directly measured by the Clock Drawing Test.

Ideally, a screening test should have the following qualities: (a) be quick to administer in order to gain acceptability among busy clinicians; (b) be well tolerated and acceptable to patients; (c) be easy to score; (d) be relatively independent of culture, language, and education; (e) have good inter-rater and test-retest reliability; (f) have high levels of sensitivity and specificity; (g) have concurrent validity (correlation with measures of severity and other dementia rating scores); and (h) have predictive validity. None of the known screening tests fit all of these criteria.

Furthermore, an individual is usually asked to wait in a defined area, generally a waiting room, until the clinician is available. The time spent waiting in this area is usually wasted from the point of view of information acquisition. At most, the individual is asked to fill out a questionnaire by hand, providing personal information and possibly answering a few questions directed to the medical reason for the visit.

Thus, it would be advantageous to have a system and method for providing screening information to a clinician which can optionally be administered during a waiting period and which is devoid of the limitations associated with known screening tests.

### SUMMARY OF THE INVENTION

According to one aspect of the present invention, there is provided a system for diagnostic evaluation of cognitive function. The system includes a screening component having output, input, and results based on the output and input, a report based on the results of the screening component, wherein the report is provided to a clinician, and a decision component provided by the clinician, wherein the decision is at least partly based on the report.

According to another aspect of the present invention, there is provided a device for screening cognitive assessment. The device includes a testing system for providing stimuli and receiving testing responses from a subject, wherein the stimuli and responses are administerable and receivable within a short time frame, a questionnaire for providing questions and receiving questionnaire responses, and a processor for processing the testing and questionnaire responses into a unified report According to yet another aspect of the present invention, there is provided a method for determining a cognitive condition of an individual. The method includes providing a device to the individual, the device including a testing segment and a questionnaire segment, collecting data from the individual in response to stimuli from the testing segment and questionnaire segment, generating a report based on the data, and providing the report to a clinician.

According to further features, in one embodiment the testing system is a tablet, suitable to be held and moved around a particular location, such as a waiting room. In another embodiment, the testing system is a stationary computer, held in a location of choice, such as a waiting room. The report can include testing performance scores, questionnaire based cognition scores, a combination of both, sub-ranges of scores, and a chart showing progression over time of an individual being tested. The time frame is preferably less than 15 minutes.

According to additional features, the system and methods of the present invention include a battery recommender, wherein results from the testing and/or questionnaire segments are used to determine an optimal battery of tests for continued examination beyond the screening phase.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a diagrammatic overview of three key components in a diagnostic evaluation system, in accordance with the present invention;

FIG. 2 is a diagrammatic overview of a screening portion of the diagnostic evaluation system of FIG. 1;

FIG. 3 is a diagrammatic overview of a testing segment which can be modified for use in the screening portion of FIG. 2;

FIG. 4 is a flow chart diagram of a screening portion in accordance with a preferred embodiment, specifically shown for a primary care battery screener;

FIG. 5 is a screen shot of images shown in a non-verbal memory test, administered within the testing segment of FIG. 3; and

FIG. 6 is a screen shot of images shown in a quiz phase of the non-verbal memory test of FIG. 5.

### DESCRIPTION OF THE PREFERRED EMBODIMENTS

The present invention is of a system and method for screening and evaluation of neurological function. Specifically, the present invention can be used to differentiate between normal and pathological function for various skills, mainly related to cognitive skills such as logic, reasoning, coordination and verbal function, as well as mood and anxiety level. It is designed to provide an initial view of cognitive function to a physician, prior to examination.

Before explaining at least one embodiment of the invention in detail, it is to be understood that the invention is not limited in its application to the details of construction and the arrangement of the components set forth in the following description or illustrated in the drawings. The general principles of the present invention will be described with reference to several embodiments. However, the invention is capable of other embodiments or of being practiced or carried out in various ways with many alternatives, modifications and variations, and many other tests may fall within the realm of the present invention. Accordingly, it is intended to embrace all such alternatives, modifications and variations that fall within the spirit and broad scope of the appended claims. Also, it is to be understood that the phraseology and terminology employed herein is for the purpose of description and should not be regarded as limiting.

The principles and operation of a testing system and method according to the present invention may be better understood with reference to the drawings and accompanying descriptions.

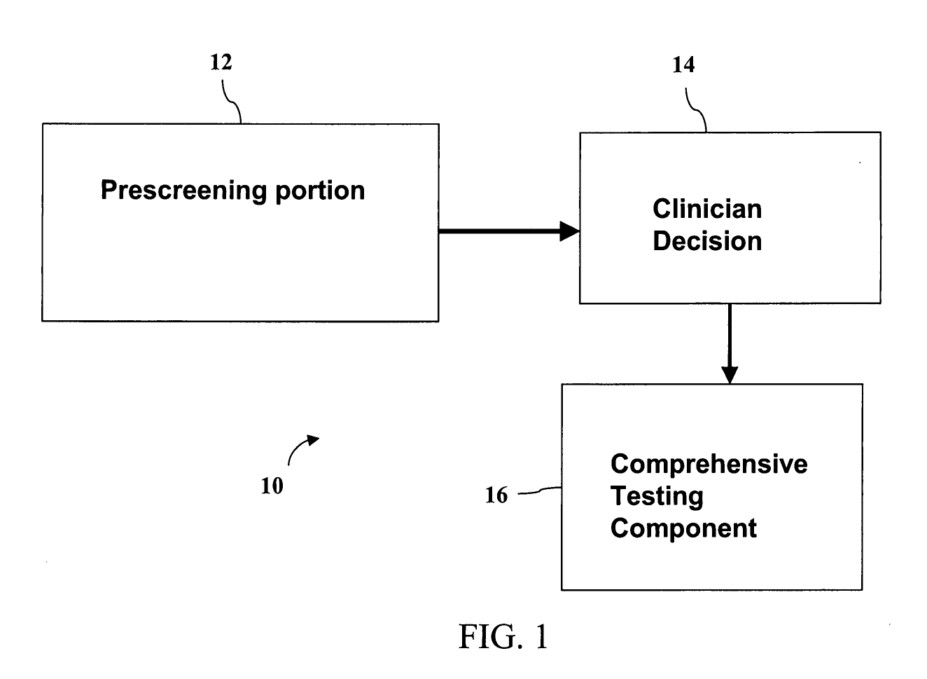

Reference is now made to FIG. 1, which depicts a diagrammatic overview of three components in a diagnostic evaluation system 10, as envisioned in accordance with the present invention. The first component is a screening portion 12. Screening portion 12 is followed by a clinician's decision 14 and a comprehensive testing component 16. Although all three of these elements contribute to the overall diagnostic evaluation system 10, the present invention is directed to the first portion, namely screening portion 12, as will be described in further detail hereinbelow. However, the structure of both decision 14 and comprehensive testing component 16 will depend on the outcome of screening portion 12. For example, in some cases, depending on the outcome of screening portion 12, the clinician will decide to do a physical examination. In other cases, results of screening portion 12 will directly lead to a decision to continue testing or to make a clinical diagnosis without a physical examination. Many other possibilities regarding decision 14 and comprehensive testing component 16 exist.

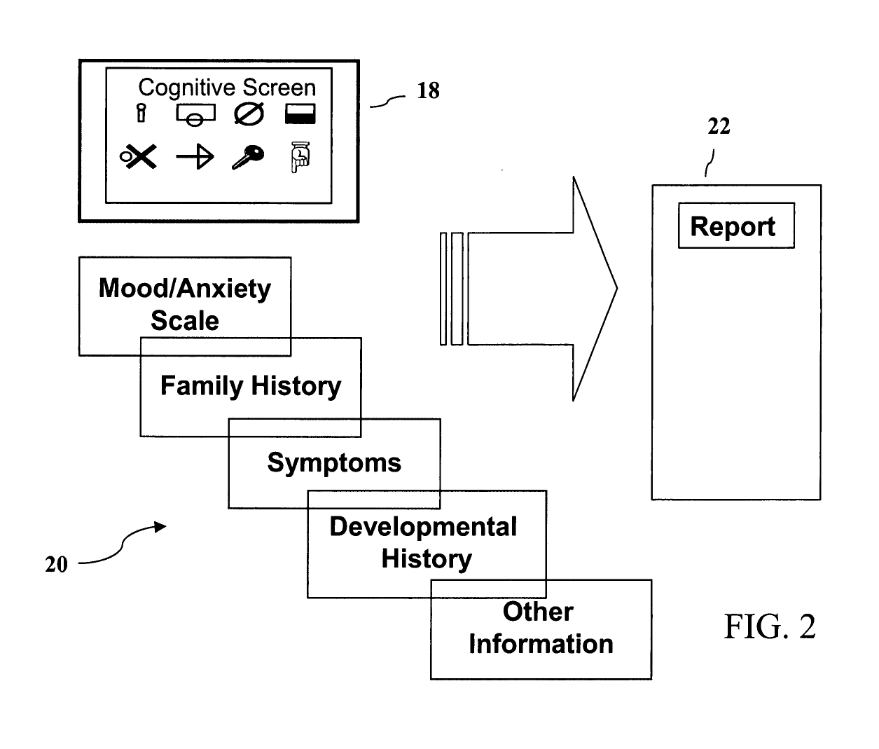

Reference is now made to FIG. 2, which is a diagrammatic overview of screening portion 12, in accordance with a preferred embodiment of the present invention. Screening portion 12 includes a testing segment 18 for cognitive pre-evaluation, and a questionnaire segment 20 for additional information. Testing segment 18 can include various tests, related to motor skills, logic, reasoning, coordination, verbal function, memory, and various other skills. Questionnaire segment 20 can include questions designed to provide information about mood, anxiety level, symptoms that the individual may be experiencing, developmental history, and personal information such as family history. In a preferred embodiment, tests included in testing segment 18 and answers to questionnaire segment 20 are designed to be completed within 15 minutes, but they may take as long as 30 minutes. A report 22 is generated based on information and data collected from testing segment 18 and questionnaire segment 20. In one embodiment, information from questionnaire segment 20 is used to modify data collected in testing segment 18. In another embodiment, information from questionnaire segment 20 is included as additional data points in calculating a final score reported in report 22. In yet another embodiment, information from questionnaire segment 20 is presented in report 22 in parallel with data collected from testing segment. The information from questionnaire segment 20 can be quantitative or qualitative, and is designed to in some way provide a clinician with an additional tool for assessment.

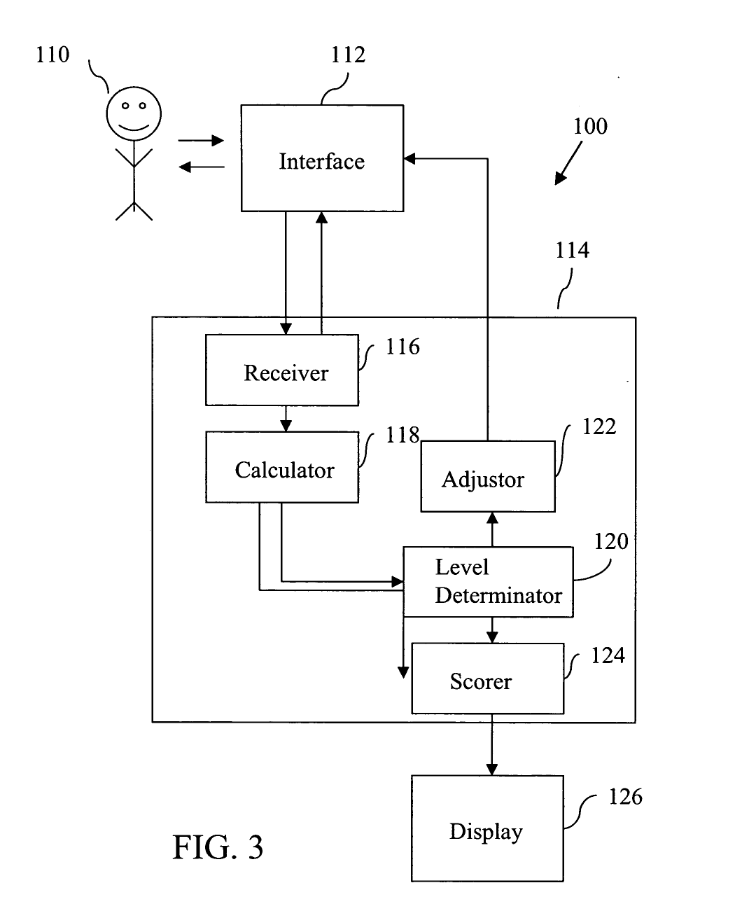

Specific tests included within testing segment 18 are designed to measure cognitive abilities on a basic level. In one embodiment, tests are adapted from known systems. Many different cognitive tests which are suitable for adaptation for the present application are described more fully in co-pending U.S. patent application Ser. No. 10/370,463, filed Feb. 24, 2003, incorporated herein by reference in its entirety. As an overview of the cognitive testing system disclosed in the above-referenced application, reference is now made to FIG. 3, which is a block diagram illustration of a testing system 100. A subject 110 being tested is in communication with testing system 100 via an interface 112. Interface 112 is configured to accept data collected by responses of subject 110 to stimuli provided by testing system 100. Interface 112 communicates with system 100 via a processor 114, configured to accept and analyze the data, provide feedback to subject 110, adjust the testing scheme, and send results. Processor 114 has a receiver 116 for receiving data, a calculator 118 for calculating performance, a level determinator 120, for determining a skill level of subject 110, an adjustor 122 for adjusting the level of testing, and a scorer 124 for determining a score based on the received data. The processor sends the processed score information to a display 126. Display 126 may be an audio or visual display, and is either directly or remotely connected to the rest of system 100.

Initially, a stimulus is presented to subject 110, who then responds to the stimulus. Both the presentation of the stimulus and the response thereto are directed through interface 112. In a preferred embodiment, interface 112 is a computer system having an input such as a mouse, keypad, joystick or any other input device, and a display for presentation of the stimulus. It should be readily apparent that any system useful for presentation of a stimulus and collection of responses may be used. However, it is preferable that interface 112 be intuitive and simple to understand. If necessary, an orientation session is provided so as to familiarize subject 110 with interface 112, thereby eliminating the possibility of bias due to lack of familiarity with the technology.

Receiver 116 collects responses from subject 110 through interface 112, and sends the data to a calculator 118. Calculator 118 calculates performance factors, such as accuracy, speed, etc. General performance is rated based on certain predefined criteria, such as threshold levels, percentage of accurate responses, or any other criterion deemed to be relevant. Calculator 118 sends performance data to level determinator 120 and to scorer 124. Level determinator 120 determines an appropriate level of testing based on the performance data, and sends the data to both adjustor 122 and to scorer 124. Adjustor 122 adjusts the level of testing, which is directed through interface 112 to subject 110 for additional testing. In many instances, the determined level is also useful in calculating a final score. Scorer 124 uses data from level determinator 120 and from calculator 118 to determine a score. The score may be presented in the form of a number, a series of numbers, a chart or a graph or any other format. The score is sent to display 126 either via direct or remote connection, which then displays the score in an easily readable format.

Specific examples of tests fit into several categories, including motor skills, visual/spatial perception, memory, information processing, verbal function, and executive function. Motor skills tests include, for example, a finger tap test, for assessing speed of tapping and regularity of finger movement; and a catch test wherein a subject is asked to catch a first object falling from the top of a screen using a second object on the bottom of the screen, for assessing hand/eye coordination, speed of movement, motor planning and spatial perception. Visual/spatial perception tests include, for example, the catch test described above; a non-verbal memory test, as described below, and a three-dimensional spatial orientation test, wherein a subject is asked to identify a view from a specific perspective, for assessing spatial perception and mental rotation capabilities. Memory tests include, for example, a verbal memory test, whose purpose is to evaluate a subject's ability to remember pairs of words that are not necessarily associated with one another; a non-verbal memory test, whose purpose is to evaluate a subject's ability to remember the spatial orientation of a picture. Information processing tests include, for example, a staged math test including simple mathematical problems to evaluate a subject's ability to process information, testing both reaction time and accuracy. Verbal function tests include, for example, a verbal naming and rhyming test using semantic foils, requiring an executive function (frontal lobes of the brain) to suppress the natural tendency towards the semantic foil, favoring the phonological choice. The naming test is a subtest of the rhyming test, which serves to test different verbal skills than the rhyming test and to control for cultural bias. Executive function tests include, for example, a stroop test, in which the subject is shown words having the meaning of specific colors written in colors other than the ones indicated by the meaning of the words; a Go/No Go Response Inhibition test to evaluate concentration, attention span, and the ability to suppress inappropriate responses; and a non-verbal IQ test to evaluate non-verbal intelligence, particularly logic and reasoning skills. Any of the above tests can be adapted for use in the testing segment of the present invention.

Tests for the testing segment 18 are designed by one of several methods. In one embodiment, one or several of the tests described above are adapted by including only the simplest levels, in order to screen out extreme cases of cognitive impairment. In an alternative embodiment, portions of a test normally used as a practice session, in which the subject is given certain simple instructions and is provided with feedback so that he/she can learn the nature of the test, as described in co-pending U.S. patent application Ser. No. 10/370,463, are adapted for use as cognitive screeners. Alternatively, or in addition to the adaptation of previous tests, new tests may be developed, including memory games, coordination tests, and any other suitable test for providing information to a clinician.

Specific screening tests are chosen according to requirements for individual patients. For example, a patient arriving with concerns about memory loss might be given a highly sensitive non-verbal memory test, to screen for the possibility of Alzheimer's disease. Alternatively, a patient arriving with possible ADHD would be given a test that screens for the ability to withhold an impulse, such as the Go/NoGo test described in more detail in the above-referenced application. More specific examples of indications and chosen tests are described below with reference to the different preferred embodiments. Generally, the highly sensitive tests would be administered for screening, even at the expense of specificity, which could be fine tuned during later testing batteries.

Questions included within questionnaire segment 20 can include various background questions normally required for medical records, including history and personal information. In addition, questions related to anxiety level and/or mood may be included, so as to provide an appropriate backdrop for the clinician to use for the more fully inclusive evaluation to follow. Previously validated instruments, such as the Geriatric Depression Scale (Sheikh and Yesavage, Clinical Gerontology: A guide to assessment and intervention, New York: Haworth, 1986: 165-73) for testing the elderly for depression, the Hamilton Anxiety Scale (Gjerris et al, J. Affect. Disord. 1983 May: 5(2): 163-70), and the Lawton-Brody Activities of Daily Living Scale (Lawton and Brody, Gerontologist, 1969, 9: 179-186), would be used.

In a preferred embodiment, screening portion 12 is housed in a light, user-friendly device, such as a tablet/notepad computer that can be supplied to an individual in, for example, a waiting area. In one embodiment, the waiting area has docking stations, each of which includes such a tablet/notepad computer. In an alternative embodiment, the computer is a wireless system which could be used anywhere in the area. Alternatively, a desktop computer is situated at a station within the waiting room. The individual is directed to a station or handed a wireless system and asked to complete the screening portion. Information and results can either be obtained by the physician either in electronic or paper (printed) format.

All information is automatically summarized into graphs and reports for quick perusal by the clinician just prior to examination. Graphs and results summaries can include comparison with other clinical rating scales. Moreover, graphs and results summaries can include past results of the individual, and an indication of progress over time. Thus, a clinician is immediately provided with an overall picture of the individual's situation, including current condition and mood, past history, treatments to date, and any other relevant data.

Based on the results, examination component 14 can be tailored to the specific characteristics of the individual, saving time and unnecessary tests. For example, a physician can make a diagnosis based solely on the screening information and an examination, the physician may decide to send the individual for further counseling and/or treatment, or the physician may perform a more extensive physical or neurological examination. Alternatively, the clinician may decide that more testing is necessary for a more complete examination of the specific areas which were highlighted in the screening and examination segments. For example, if coordination were highlighted as a specific problem area, a more extensive battery of tests for coordination could be prescribed. In a preferred embodiment, suggested batteries of tests for further evaluation would be provided based on the preliminary results obtained by the screener. Tests for the final, extensive portion could optionally be obtained from co-pending U.S. patent application Ser. No. 10/370,463, previously incorporated by reference herein in its entirety. Conversely, further tests would not have to be given to those who pass the screening tests, thus saving time and money. All collected information is stored in a database, and is then available for any subsequent visits.

Since the purpose of the system and methods of the present application is to act as a screening tool, it is designed in such a way that individuals with even mild cognitive impairment will be followed up with more extensive assessment. Thus, it must be sensitive enough to detect mild disease with a high level of confidence. That is, it should have a low false negative rate (p[FN]); the screener must only infrequently classify cognitively impaired individuals as cognitively healthy. The system and methods of the present application are designed to be more tolerant of errors whereby a recommendation is rendered for a cognitively healthy individual to undergo more comprehensive assessment. That is, the false positive rate (p[FP]) should be kept low, but may be sacrificed for the sake of the more important task of keeping the false negative rate (p[FN]) low since the consequence of a false positive error is that the individual will be followed up with more comprehensive assessment that should ultimately rule out cognitive impairment. However, the consequence of a false negative error is that the individual will not be diagnosed and treated even though he has a dementing illness, a consequence which should be avoided with a screening tool. Thus, cutoff points for results are calculated based on a low p[FN] and a moderate p[FP], with expert diagnosis taken as the gold standard, as will be explained more fully hereinbelow.

### EMBODIMENT 1

### Primary Care Battery

A screener is provided for cognitive impairment (mild cognitive impairment or more severe states of dementia), and a practitioner is provided with either a normal designation, a recommendation to pursue further testing using a mild impairment battery of tests, or a recommendation to pursue further testing using a severe impairment battery of tests.

Initially, a subject is presented with a brief orientation session, which includes simple instructions regarding how to use the mouse, joystick or other controls, as well as a familiarization with the type of testing. If the subject has difficulty with this session, he/she is automatically referred to a Moderate/Severe Impairment Battery for further testing. For most subjects who are not in extreme stages of dementia, the following protocol will help to screen out potential candidates for further testing, and may also provide a recommendation as to what further tests may be appropriate.

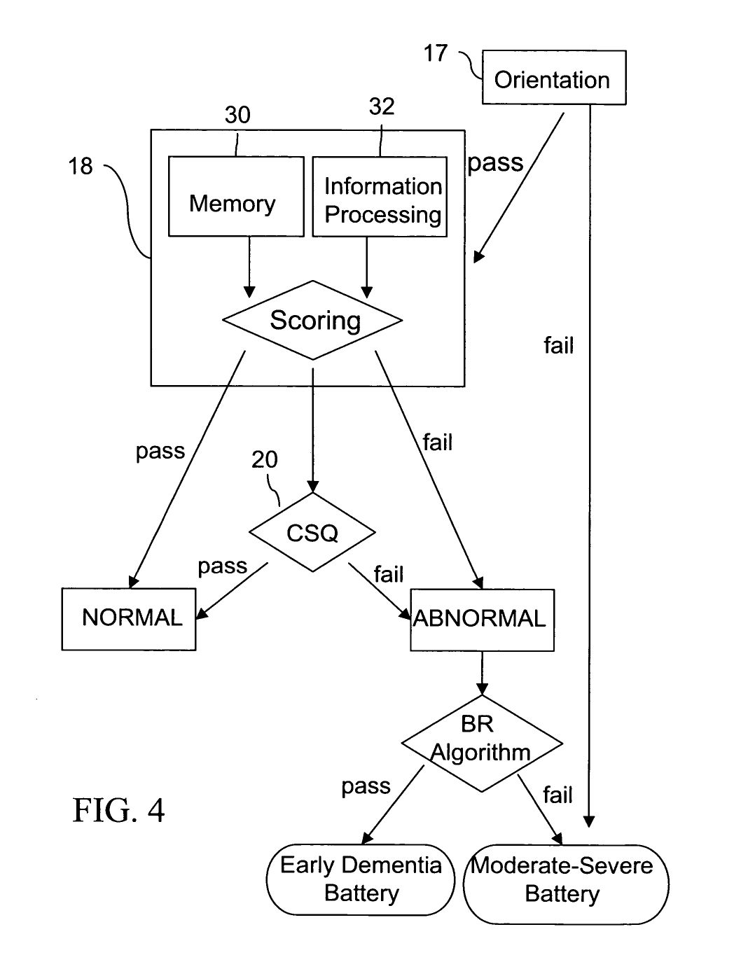

Reference is now made to FIG. 4, which is a block diagram illustration of an overview of screening for cognitive impairment in accordance with a preferred embodiment of the present invention. An orientation session 17 is initially presented to a subject. If the subject fails to perform adequately on orientation session 17, he/she is automatically recommended to a Moderate/Severe testing battery. If the subject passes orientation session 17, a testing segment 18 is provided to the subject. Testing segment 18 includes a Non-Verbal Memory Test 30, and a Staged Information Processing Test 32, both described more fully below. It should be readily apparent that other tests designed to measure cognitive function may be included in addition to or in lieu of these two tests. Subjects are then provided with questionnaire segment 20, which in this preferred embodiment is a cognitive symptom questionnaire (CSQ). The CSQ can be completed by either the subject or a caregiver. Results of the tests are scored, and designations of “normal” (pass), “abnormal” (fail), or “consult CSQ” are provided, based on performance scores falling within predetermined cutoffs and ranges for each category. If the designation is “normal”, the subject is classified as normal and the screening test ends. If the designation is “abnormal”, the clinician is presented with a recommendation of which battery of tests to use for continued testing: either an early dementia battery, or a moderate-severe battery. If the designation is “consult CSQ”, answers given on the questionnaire are used to help make a designation of “normal” or “abnormal”. In one embodiment, answers to questions from the questionnaire are used to produce questionnaire based cognition scores. If the designation based on the questionnaire is “normal”, the subject is classified as normal and the screening test ends. If the designation based on the questionnaire is “abnormal”, the clinician is presented with a recommendation of which battery of tests to use for continued testing.

In an alternative embodiment, the order of consideration of results is reversed. That is, results from the CSQ are considered first, and an initial designation of “normal”, “abnormal” or “continue with screening test” are provided, followed by cognitive testing and recommendations regarding further testing based on performance scores. In yet another embodiment, questionnaire based cognition scores are included in an algorithm and are used by the processor to automatically provide a designation of “normal” or “abnormal” or to produce a combined score. Furthermore, the step of providing a recommendation can also be included within the processor and automatically provided to the clinician.

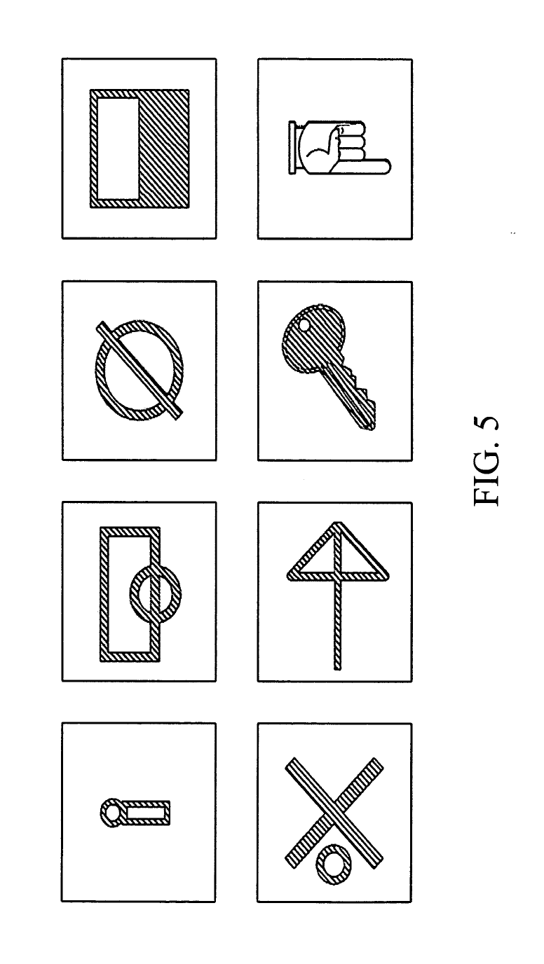

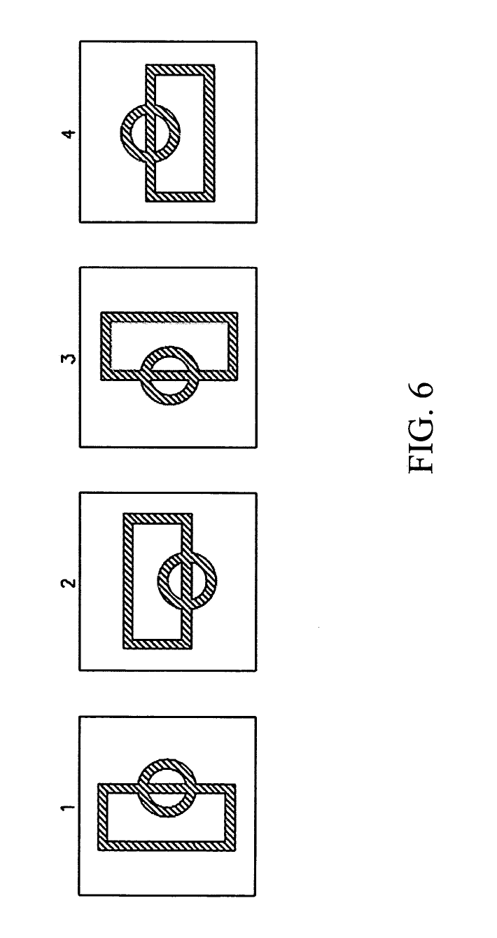

Specific details of the elements described with reference to FIG. 4 are now provided. Reference is now made to FIGS. 5 and 6, which are examples of screen shots of images shown in Non-Verbal Memory Test 30. It should be readily apparent that the images are not limited to the ones shown herein, but rather, any suitable images may be used. As shown in FIG. 5, several images are shown together for 20 seconds. Subsequently, one of the images from the screen shot of FIG. 5 is shown in several possible orientations, such as is depicted in FIG. 6. The subject is asked to choose the correct orientation. The outcome parameters for this test are accuracy for a first immediate repetition and accuracy for a second immediate repetition.

Staged Information Processing Test 32 requires a binary decision based on the solution of simple arithmetic problems. The test includes two basic levels. At the first level, the subject is shown a number and told that if the depicted number is higher than a certain number, he/she should press the right mouse button and if the depicted number is less than or equal to a certain number, he/she should press the left mouse button. If the subject presses the correct mouse button, the system responds positively to let the subject know that the correct method is being used. This level is split into three subsection levels, performing the same quiz as the trial session, but at increasing speeds and without feedback to the subject. The speed of testing is increased as the levels increase by decreasing the length of time that the stimulus is provided. Thus, in a preferred embodiment, the first set of stimuli are provided for 1500-2500 ms each, the next set for 750-1500 ms each and the final set for 100-750 ms each. In all three subsection levels, the duration between stimuli remains the same (1000 ms in a preferred embodiment).

The next level of testing involves solving an arithmetic problem. The subject is told to solve the problem as quickly as possible, and to press the appropriate mouse button based on the answer to the arithmetic problem. For example, the subject is given instructions that if the answer to the problem is 4 or less, press the left mouse button, and if the answer to the problem is greater than 4, press the right mouse button. The arithmetic problem is a simple addition or subtraction of single digits. This level is administered at one speed. A minimum of 10 stimuli is provided for each level.

Although the setup of the test described above is a preferred embodiment for screening purposes, it should be readily apparent that additional levels are possible as well. For example, the second level can be performed at various speeds. Also, a third level may be introduced, in which a more complicated arithmetic problem is introduced. For example, two operators and three digits may be used. In addition, the third level can be administered at various speeds.

It should be noted that the mathematical problems are design to be simple and relatively uniform in the dimension of complexity. The simplicity is required so that the test scores are not highly influenced by general mathematical ability. The stimuli are also designed to be in large font, so that the test scores are not highly influenced by visual acuity. In addition, since each level also has various speeds, the test has an automatic control for motor ability. Outcome parameters include a performance index for each level of testing.

The processor combines results/outcome parameters to provide a testing score. In a preferred embodiment, normalized Non-Verbal Memory Test 30 outcome parameters are averaged to give a memory component, and Staged Information Processing Test 32 outcome parameters are averaged to give an information processing component. Each of these components is scored according to specific sub-ranges defined as abnormal, probable abnormal, probable normal and normal. Calculations showing the cutoff scores for each of these sub-ranges and how they were devised are discussed more fully in a co-pending U.S. application (Serial Number not yet assigned) entitled: Standardized Medical Cognitive Assessment Tool, filed on Oct. 25, 2004, incorporated by reference herein in its entirety. The cutoffs have been shown to be appropriate for these ranges and sub-ranges based on false positive and false negative rates as compared to a gold standard expert diagnosis. It should be noted, though, that the use of other numbers as cutoff points is possible. If performance on either Memory Test 30 or Processing Test 32 is “abnormal”, or if both are classified as “probably abnormal”, the resulting designation is “abnormal” and the subject has failed. If performance on both tests is “normal”, the resulting designation is “normal” and the subject has passed. In all other cases, the designation is “consult CSQ”.

The CSQ includes several questions related to cognitive state. In a preferred embodiment, the questions include some or all of the following: 1. Does the patient have trouble remembering things that have happened recently (for example, asking the same questions or repeating the same thing over and over)? 2. When speaking, does the patient have more difficulty finding the right word, or does he/she tend to use the wrong word? 3. Is the patient less able to manage money and financial affairs (e.g., paying bills, budgeting)? 4. Is the patient less able to manage his/her medications independently? It should be readily apparent that different phraseology or content may be used in the CSQ, as long as the questions are designed to collect information about cognitive symptoms. When the CSQ is consulted, it is required that a minimum of two cognitive symptoms be reported for an individual to be classified as “abnormal”. Otherwise, the individual is classified as “normal”.

An overall “abnormal” classification indicates that the individual should be followed up with additional cognitive testing, without specifying which cognitive battery would be most appropriate. In order to provide clinicians with information about further testing, a battery recommendation algorithm is used. In a preferred embodiment, the processor includes a battery recommender algorithm. For cognitive impairment, the two options for further testing upon “abnormal” designation are either an Early Dementia Battery, or a Moderate/Severe Impairment Battery. In order to be recommended to the Moderate/Severe Impairment Battery, the subject would have to perform very poorly on both tests. Otherwise, the battery recommender recommends the Early Dementia Battery for further testing.

The Early Dementia Battery is a battery of tests suitable for detecting MCI. This battery includes tests for verbal memory, non-verbal memory, Go/NoGo, Stroop, visual/spatial, and the catch game. A pass/fail determination is made for each outcome parameter on the basis of a cutoff value with equivalent sensitivity and specificity for distinguishing among patients with an expert diagnosis of cognitively healthy and those with a diagnosis of mild dementia. The total number of “failed” parameters is computed, and the result is converted to a 10 point scale. The scale is split into three performance zones, with a “normal” zone from 0 to 2.5, an “MCI” zone from 2.5 to 7.5, and a “dementia” zone from 7.5 to 10. The battery is relatively short (approximately 30 minutes testing time).

The Moderate/Severe battery is a much less difficult set of exams. It includes exams found in the Early Dementia Battery, but the tests are much shorter, less difficult, and require much less direct interaction between the subject and computer.

### EMBODIMENT 2

### Childhood Learning Disorders Primer

In another embodiment, a screener is provided for learning disorders, such as attention deficit disorder (ADD), attention deficit hyperactivity disorder (ADHD), dyslexia, poor motor coordination, or other childhood difficulties commonly tested in school settings and pediatricians offices. Similar screeners may be provided for juvenile depression, juvenile anxiety and other psychiatric illnesses in children.

Similar to the first embodiment described above, a testing segment 18 and a questionnaire segment 20 are provided to a subject. Testing segment 18 includes cognitive tests such as memory tests, tests for executive function, and tests for attention, as well as a test of hand-eye (visuomotor) coordination. Questionnaire segment 20 in this preferred embodiment can include several questionnaires, including a cognitive symptom questionnaire (CSQ), typically filled out by a parent or caregiver, a developmental history questionnaire, and a family history questionnaire. Any or all of these questionnaires may be administered simultaneously or one after another, either all to the same person or to several relevant people at the same time.

Results of the tests are scored, and designations of “normal” (pass), “abnormal” (fail), or “consult questionnaire” are provided, based on performance scores falling within predetermined cutoffs and ranges for each category. If the designation is “normal”, the subject is classified as normal and the screening test ends. If the designation is “abnormal”, the clinician is presented with a recommendation of which battery of tests to use for continued testing: for example, an ADHD battery, a Global Assessment Battery, a Reading Disorders Battery, a Visuomotor Assessment Battery, or additional batteries. If the designation is “consult questionnaire”, answers given on the questionnaire are used to help make a designation of “normal” or “abnormal”. In one embodiment, answers to questions from the questionnaire are used to produce questionnaire based cognition scores. If the designation based on the questionnaire is “normal”, the subject is classified as normal and the screening test ends. If the designation based on the questionnaire is “abnormal”, the clinician is presented with a recommendation of which battery of tests to use for continued testing.

In an alternative embodiment, the order of consideration of results is reversed. That is, results from the questionnaire segment 20 are considered first, and an initial designation of “normal”, “abnormal” or “continue with screening test” are provided, followed by cognitive/visuomotor testing and recommendations regarding further testing. In yet another embodiment, questionnaire based cognition scores are included in an algorithm and are used by the processor to automatically provide a designation of “normal” or “abnormal” or to produce a combined score. Furthermore, the step of providing a recommendation can also be included within the processor and automatically provided to the clinician. In a preferred embodiment, the processor includes a battery recommender algorithm.

Report:

The report is available immediately over the internet or by any other communication means. The report includes a summary section and a detailed section. In the summary section, scores on cognitive tests are reported as normalized for age and educational level and are presented in graphical format, showing where the score fits into pre-defined ranges and sub-ranges of performance. It also includes graphical displays showing longitudinal tracking (scores over a period of time) for repeat testing. Also, the answers given to the questionnaire questions are listed. Finally, it includes a word summary to interpret the testing results in terms of the likelihood of cognitive abnormality. The detailed section includes further details regarding the orientation and scoring. For example, it includes results for computer orientation for mouse and keyboard use, word reading, picture identification, and color discrimination. Scores are also broken down into raw and normalized scores for each repetition. Thus, a clinician is able to either quickly peruse the summary section or has the option of looking at specific details regarding the scores and breakdown. Each of these sections can also be independently provided.

Validation of Cutoff Scores for Predicting Cognitive Impairment with High Sensitivity

Methods

340 patients (mean age: 74.5±7.3 years; mean education: 13.4±3.6 years) from 8 research sites in the United States (Case Western Reserve University, Cleveland, Ohio; Emory University, Atlanta, Ga.; State University of New York-Downstate, Brooklyn, N.Y.), Canada (McGill-Jewish General Hospital, Montreal, Canada), and Israel (Ben-Gurion University of the Negev, Beer Sheva, Israel; The Ramat Tamir Home for the Aged, Jerusalem, Israel; Shaare Zedek Medical Center, Jerusalem, Israel; Sourasky Medical Center, Tel Aviv, Israel) served as a development sample for the computerized portion of the screener described herein. All patients completed a Global Assessment Battery, described below, and were diagnosed independently with mild cognitive impairment (MCI), mild dementia, or as cognitively healthy. Diagnosis was by consensus of evaluation teams led by dementia experts at each of the sites. Diagnosis of MCI followed Petersen et al. (1999) and included the following features: (1) a complaint of defective memory; (2) normal activities of daily living; (3) a deficit documented by performance on a standardized neuropsychological test of memory; and (4) absence of dementia. These criteria define the subtype of MCI known as ‘MCI-amnestic’ (Petersen et al., 2001). Diagnosis of dementia was according to Diagnostic and Statistical Manual, 4th ed. (DSM-IV) criteria for Dementia of the Alzheimer's Type. Healthy elderly had no memory complaint or demonstrated normal performance on a standardized neuropsychological test of memory.

Participants at one site (The Ramat Tamir Home for the Aged; N=35) completed the Reisberg Global Deterioration Scale (RGDS; Reisberg et al., 1982). Participants at two other sites (Emory University, Ben-Gurion University of the Negev; N=54) completed a 4-question cognitive symptoms questionnaire as described above with reference to questionnaire segment 20.

For patients with multiple visits, only data from the first visit was included. Only patients whose primary language (i.e., most comfortable using or used most often) was available as a test language were included.

Global Assessment Battery:

The Global Assessment Battery (testing time: ˜50 minutes) produces 83 outcome parameters from 10 tests that sample various cognitive domains, including memory (verbal and non-verbal), executive function, visual spatial skills, verbal fluency, attention, information processing, and motor skills. Given the speed-accuracy tradeoff (Cauraugh, 1990), a performance index (computed as [accuracy/RT]*100) was computed for timed tests in an attempt to capture performance both in terms of accuracy and RT. To minimize differences in age and education and to permit averaging performance across different types of outcome parameters (e.g., accuracy, RT), each outcome parameter was normalized and fit to an IQ-style scale (mean: 100, SD: 15) in an age- and education-specific fashion.

A total of 6 normalized outcome parameters particularly relevant for identification of MCI and mild dementia were selected for inclusion in an ‘MCI Score’. These outcome parameters were: 1) Verbal Memory: accuracy; 2) Non-Verbal Memory: accuracy; 3) Go-Nogo: performance index; 4) Stroop: performance index for Stroop interference phase; 5) Visual Spatial Imagery: accuracy; and 6) Catch Game: total score (summed accuracy across levels, weighted by difficulty). A pass/fail determination was made for each outcome parameter on the basis of the cutoff value with equivalent sensitivity and specificity for distinguishing among patients with an expert diagnosis of cognitively healthy and those with a diagnosis of mild dementia. The total number of outcome parameters ‘failed’ was computed and the result converted to a 10-point scale. This scale was split into three performance zones, a ‘Normal’ zone from 0 to 2.5, a ‘MCI’ zone between 2.5 to 7.5, and a ‘Dementia’ zone from 7.5 to 10.

For purposes of the present analysis, MCI Score classifications of ‘MCI’ and ‘Dementia’ were considered to have ‘abnormal’ Early Dementia Battery performance and those with classifications of ‘Normal’ to have ‘normal’ battery performance. An MCI Score was not computed in the event of missing data for 3 or more constituent outcome parameters.

The 83 normalized outcome parameters produced by the Global Assessment Battery were analyzed to select an appropriate subset for inclusion in the screener. Given that individuals designated as ‘Normal’ will receive a recommendation that there is no need for further cognitive testing, it was deemed most important to ensure that the proportion of patients who pass the computerized portion of the screener would, in fact, score as ‘Normal’ on the Early Dementia Battery if it were subsequently administered. It was therefore deemed most important that the pass/fail cutoff selected for the computerized portion of the screener and hence the outcome parameters that comprise it, have a high negative predictive value (NPV) in identifying those who would have received an ‘abnormal’ MCI Score (positive group) as compared to those who would have received a ‘normal’ MCI Score (negative group) in the development sample.

Given that high sensitivity is associated with high NPV and to permit relative comparison of NPVs across outcome parameters, NPV was compared across outcome parameters at the cutoff corresponding to a sensitivity of 0.90. The 10 outcome parameters with the highest NPV values at a sensitivity of 0.90 were from three tests: Verbal Memory, Non-Verbal Memory, and Staged Information Processing Speed, as described above.

Given that the screener must be suitable even for individuals with little formal education, the Verbal Memory test was deemed inappropriate. Two outcome parameters with high NPVs from each of the remaining tests were selected for inclusion in the screener. The two Non-Verbal Memory test outcome parameters were: accuracy for the second immediate repetition and accuracy for the third immediate repetition. The two Staged Information Processing Speed outcome parameters were: performance index, single digit/slowest speed phase and performance index, 2-digit arithmetic/slowest speed phase. The (normalized) Non-Verbal Memory test outcome parameters were averaged to give a ‘Memory’ component, and the Staged Information Processing Speed test outcome parameters were averaged to give an ‘Information Processing’ component.

When implemented in the screener, the Memory component and the Information Processing component are each scored according to the following sub-ranges: ≦85 is ‘Abnormal’; >85 and ≦96.25 is ‘Probable Abnormal’; >96.25 and ≦103.25 is ‘Probable Normal’; >103.25 is ‘Normal’. In a previous analysis, described more fully in a co-pending U.S. application (Serial Number not yet assigned) entitled: Standardized Medical Cognitive Assessment Tool, filed on Oct. 25, 2004, incorporated by reference herein in its entirety, these sub-ranges were shown to be appropriate on the basis of false positive rate (p[FP]) and false negative rate (p[FN]) for identifying a variety of cognitive deficits with expert diagnosis taken as the “gold standard”. p(FP) in the ‘Abnormal’ range is less than approximately 0.1 and in the ‘Probable Abnormal’ range less than approximately 0.3. Conversely p(FN) in the ‘Normal’ range is less than approximately 0.1 and in the ‘Probable Normal’ range less than approximately 0.3. These sub-ranges were shown to be appropriate for ‘index’ scores summarizing performance in a given cognitive domain and computed in the same way as the Memory and Information Processing components of the screener.

Suitability of Early Dementia Battery was determined by comparison of raw scores from the screener with proven scores from the Early Dementia Battery as follows. In addition to the MCI Score, the Early Dementia Battery produces four ‘index scores’ summarizing performance in particular cognitive domains. Each index score is computed as the average of normalized sets of outcome parameters as follows:
MEMORY: mean accuracies for learning and delayed recognition phases of Verbal and Non-Verbal Memory tests
EXECUTIVE FUNCTION: performance indices (accuracy divided by reaction time) for Stroop Interference test and Go-NoGo Response Inhibition test, mean weighted accuracy for Catch Game
VISUAL-SPATIAL: mean accuracy for Visual Spatial Orientation test
ATTENTION: mean reaction times for Go-NoGo Response Inhibition (either standard or expanded) and choice reaction time (a non-interference phase of the Stroop test) tests

A Global Cognitive Score (GCS) was computed as the average of these index scores. Memory, Executive Function and Attention index scores were computed only if data was present for at least two of their constituent outcome parameters. A GCS would not be computed if one or more index scores were missing.

As the MCI Score, index scores, and GCS comprise the clinical assessment report furnished to physicians following the Early Dementia Battery, these measures were used to determine battery suitability. Given that missing outcome parameter data was attributable to response patterns indicative of poor compliance with test instructions, the normalized score equivalent to 2 percentile units based upon the normative sample, was inserted for missing outcome parameter and index score data in this analysis.

Lack of Early Dementia Battery suitability was indicated if any one of the following conditions was met: a) mean performance across all outcome parameters contributing to index scores less than 75 normalized units; b) mean performance across all index scores less than 75 normalized units; c) GCS invalid (i.e., missing data for one or more index scores); d) MCI Score invalid (i.e., missing data for three or more constituent outcome parameters; see above).

Raw (i.e., non-normalized with no cap on poor performance or low score inserted in the event of a failed practice session) data from outcome parameters produced by the computerized portion of the screener was utilized to ‘predict’ suitability of the Early Dementia battery as defined here. An algorithm with a low p(FP) and a moderate p(FN) was devised (positive group=Early Dementia Battery unsuitable) and required a) an accuracy of ≦13 or missing on the 2nd immediate repetition and the 3rd immediate repetition of the Non-Verbal Memory test, and b) a missing accuracy for the single digit/fastest speed phase or the 2-digit arithmetic/slowest speed phase of the Staged Information Processing Speed test. In the development sample, this algorithm had a p(FP) of 0.08 and a p(FN) of 0.42. Hence on the basis of the development sample, a battery recommendation that an individual with a screener classification of “Abnormal” receive the Moderate-Severe Battery (‘fail’) is associated with only an 8% chance that the Early Dementia Battery would actually have been suitable. However, a recommendation that the individual receive the Early Dementia Battery (‘pass’) is associated with a 42% chance that the Early Dementia Battery would actually be unsuitable. Given that Early Dementia Battery tests have been validated (Dwolatzky et al., (2003): Validity of a novel computerized cognitive battery for mild cognitive impairment. BMC Geriatr, 3, 4) and that summary measures on the Early Dementia report are normalized according to age and education, this balance between p(FP) and p(FN) was deemed acceptable. A low p(FN) and a moderate p(FP) were further deemed acceptable given inclusion of the specialized MCI Score on the Early Dementia report and hence the clinical utility of a report that reflects even consistently poor performance. It should be apparent that various other criteria may be chosen for determining suitability of the Early Dementia Battery.

Normalization

Normalization was according to a normative sample consisting of 483 participants with an expert diagnosis of conginitively healthy in controlled research studies. All cognitively healthy individuals in the development sample (N=150) were also part of the normal sample.

Data was normalized according to the following stratifications:

| Age | Years of | |
|---|---|---|
| Group | Education | N¹ |
| ≦18 | ≦12 | 59 |
| | >12 | |
| >18 and | ≦12 | 40 |
| ≦50 | >12 | 11 |
| | | 4 |
| >50 and | ≦12 | 49 |
| ≦70 | >12 | 89 |
| >70 | ≦12 | 45 |
| | >12 | 85 |

¹maximum across all outcome parameters.

In the event of a failed practice session, a score equivalent to 2 percentile units was assigned. This score was also assigned for performance index outcome parameters in the event of 0% accuracy on the actual test. To limit the influence of extreme outliers, actual test performance of poorer than −4SD was replaced with the normalized score for −4SD.

Results

CSO Group

Evaluation of the screener classification for the CSQ group (N=54), with caregiver-obtained CSQ responses, yielded a p(FP) of 0.40 and a p(FN) of 0.16. Overall misclassification rate was 0.20. Error rates were identical for patient-obtained CSQ responses though screener classifications for two individuals differed between caregiver-and patient-obtained groups. Hence only 16% of the time did the screener incorrectly classify an individual as “Normal” and thus fail to recommend further testing when it would actually be indicated. 40% of the time, the screener recommended further testing when it would not have been indicated on the basis of expert diagnosis. This FP rate is acceptable because 75% of “misclassified” individuals (3 of 4 for both caregiver- and patient-obtained CSQ responses) would receive an invalid MCI Score or an MCI Score classification indicative of impairment on the Early Dementia Battery despite their expert diagnosis. With a low p(FN) and a moderate p(FP), the screener maximizes chances of following up in the event of true cognitive impairment.

For individuals with a screener classification of “Abnormal” in the CSQ group with caregiver-obtained CSQ responses (N=41), p(FP) for the battery recommendation was 0.08 and p(FN) was 0.67. Overall misclassification rate was 0.12. The same error rates were obtained for individuals classified as “Abnormal” in the CSQ group with patient-obtained responses (N=41). Hence, as in the entire development sample, chances were low that the Moderate-Severe Battery would be recommended when the Early Dementia Battery was actually suitable, but chances appeared better that the Early Dementia Battery would be recommended when it was actually unsuitable. This balance of FPs and FNs is reasonable given that even an “unsuitable” Early Dementia report is telling. Notably, the high p(FN) may be an artifact of this small sample as for only three individuals in each of these CSQ samples was the Early Dementia Battery designated unsuitable on the basis of index scores Rberg Group Given that results were identical for the CSQ group irrespective of whether responses were caregiver- or patient-obtained, only one set of results is reported for the CSQ+Rberg group.

Evaluation of the screener classification for the CSQ+Rberg group (N=89) yielded a p(FP) of 0.60 and a p(FN) of 0.13. Overall misclassification rate was 0.24. Similar to the CSQ group alone, only infrequently did the screener fail to recommend further testing when it would have been indicated on the basis of expert diagnosis. More often did the screener recommend further testing when it would not have been indicated on the basis of expert diagnosis. Notably, 92% of “misclassified” individuals (11 of 12) would receive an invalid MCI Score or an MCI Score classification indicative of impairment on the Early Dementia Battery.

For individuals in the CSQ+Rberg group with a screener classification of “Abnormal” (N=72), p(FP) for the battery recommendation was 0.08 and p(FN) was 0.33. Overall misclassification rate was 0.11. Consistent with the entire development sample and the CSQ only group, an inappropriate recommendation for follow-up with the Moderate-Severe Battery was unlikely, but an inappropriate recommendation for follow-up with the Early Dementia Battery was somewhat more likely. That analysis of this larger sample evidences a smaller p(FN) relative to the CSQ only group (0.33 versus 0.67) but maintains a similar overall misclassification rate supports the idea that the higher p(FN) in the CSQ only group is an artifact of small sample size.

1. A system for diagnostic evaluation of cognitive function, the system comprising:
a screening component, said screening component comprising output, input, and results based on said output and input;
a report based on said results of said screening component, said report provided to a clinician; and
a decision component provided by said clinician, wherein said decision is at least partly based on said report.

2. The system of claim 1, wherein said output includes cognitive testing stimuli and said input includes responses to said stimuli.

3. The system of claim 2, wherein said output further includes questions in a questionnaire and said input further includes answers to said questions.

4. The system of claim 1, wherein said results include testing performance scores.

5. The system of claim 4, wherein said results further include questionnaire based cognition scores.

6. The system of claim 1, wherein said screening component is a tablet device.

7. The system of claim 6, wherein said tablet device is wireless.

8. The system of claim 1, wherein said decision includes continuing with a physical examination.

9. The system of claim 1, wherein said decision includes continuing with a neurological examination.

10. The system of claim 1, further comprising a comprehensive testing component, based on results of said report.

11. The system of claim 1, wherein said report includes sub-ranges of cognitive function.

12. The system of claim 11, wherein said sub-ranges include normal, probable normal, probable abnormal, and abnormal.

13. The system of claim 1, wherein said screening component has high sensitivity.

14. The system of claim 1, wherein said report is automatically generated.

15. A device for screening cognitive assessment, the device comprising:
a testing system for providing stimuli and receiving testing responses from the subject, wherein said stimuli and testing responses are administerable and receivable within a short time frame;
a questionnaire for providing questions and receiving questionnaire responses;
and
a processor for processing said testing and questionnaire responses into a unified report.

16. The device of claim 15, wherein said testing system is a tablet, suitable to be held and moved around a particular location.

17. The device of claim 16, wherein said particular location is a waiting room.

18. The device of claim 15, wherein said report includes sub-ranges of cognition.

19. The device of claim 18, wherein said sub-ranges include normal, probable normal, probable abnormal, and abnormal.

20. The device of claim 15, wherein said report includes a summary of said testing responses alongside said questionnaire responses.

21. The device of claim 15, wherein said processor incorporates said questionnaire responses and said testing responses into a combined score, and wherein said report includes said combined score.

22. The device of claim 15, wherein said report includes a chart showing progression over time of an individual being tested.

23. The device of claim 15, further comprising an orientation session for familiarizing a subject with said testing system.

24. The device of claim 23, wherein said processor further comprises a battery recommender for providing a recommendation of a further battery of tests, said recommendation based on said orientation session.

25. The device of claim 15, wherein said processor further comprises a battery recommender for providing a recommendation of a further battery of tests, said recommendation based on said testing responses.

26. The device of claim 15, wherein said cognitive assessment is an assessment of mild or severe cognitive impairment.

27. The device of claim 26, wherein said testing system comprises a non-verbal memory test and a staged information processing test.

28. The device of claim 26, wherein said questionnaire comprises questions about cognitive symptoms.

29. The device of claim 27, wherein said report includes a designation of “fail”, “pass”, or “requires more testing”, said designation based on results from both said non-verbal memory test and said staged information processing test.

30. The device of claim 29, wherein said designation is additionally based on said questionnaire responses.

31. The device of claim 15, wherein said cognitive assessment is an assessment of a learning disorder.

32. The device of claim 31, wherein said testing system comprises an ADHD test.

33. The device of claim 15, wherein said short time frame is less than 15 minutes.

34. A method for determining a cognitive condition of an individual, said method including:
providing a device to said individual, said device including a testing segment and a questionnaire segment;
collecting data from said individual in response to stimuli from the testing segment and questionnaire segment;
generating a report based on said data; and
providing said report to a clinician.

35. The method of claim 34, wherein said steps of providing, collecting and generating are done within a 15 minute period.

36. The method of claim 34, wherein said testing segment includes stimuli designed to test cognitive function.

37. The method of claim 34, wherein said cognitive condition is mild or severe cognitive impairment.

38. The method of claim 34, wherein said cognitive condition is a learning disability.

39. The method of claim 34, wherein said generating includes providing a summary of said testing responses alongside said questionnaire responses.

40. The method of claim 34, wherein said generating includes incorporating said questionnaire responses and said testing responses into a combined score, and wherein said providing includes providing said combined score.

41. The method of claim 34, wherein said providing includes providing a chart showing progression over time of an individual being tested.

42. The method of claim 34, further comprising providing a recommendation of a further battery of tests, said recommendation based on said data.

43. The method of claim 34, wherein said testing segment comprises a non-verbal memory test and a staged information processing test.

44. The method of claim 34, wherein said questionnaire segment comprises questions about cognitive symptoms.

45. The method of claim 43, wherein said providing includes providing a designation of “fail”, “pass”, or “requires more testing”, said designation based on results from both said non-verbal memory test and said staged information processing test.

46. The method of claim 45, wherein said designation is additionally based on said questionnaire responses.

47. The method of claim 34, wherein said generating is automatically done by a processor within said device.
